(19) United States
(12) Patent Application Publication
(10) Pub. No.: US 2003/0093483 A1
(43) Pub. Date: May 15, 2003

(54) System and method for facilitating email communications by providing convenient access to most recently and/or frequently used email addresses

(76) Inventors: Kram Henry Allen, Meridian, ID (US); Linn James Kropf, Boise, ID (US); Clifford Lee Coppinger, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/991,291

(22) Filed: Nov. 13, 2001

(51) Int. Cl. G06F 15/16

(52) U.S. Cl. 709/207; 709/206; 709/224

(57) ABSTRACT

A system for facilitating email communications. The system includes a first mechanism for monitoring when emails are sent and/or how often the emails are sent to different email addresses and providing a signal in response thereto. A second mechanism selectively displays a list of most recently used email addresses and/or most frequently used email addresses based on the signal and based on user input. In a specific embodiment, the first mechanism includes email address usage-tracking software that interfaces with email communications software. Email address sorting software communicates with the email address usage-tracking software and employs a data structure that contains priorities associated with a predetermined number of email addresses. The predetermined number of email addresses is user-configurable via a user-interface to the email address sorting software. The email address sorting software sorts email addresses in a data structure according to priority values assigned to each email. The priority values are based on both user-input to the email address sorter and the signal. The second mechanism includes an additional mechanism that displays a sorted drop-down list or menu of email addresses selected from the data structure and sorted according to the priority values.

### BACKGROUND OF THE INVENTION

1. Field of Invention

This invention relates to communications software. Specifically, the present invention relates to systems and methods for organizing email addresses in communications software applications.

2. Description of the Related Art

Electronic mail (email) communications systems are employed in various demanding applications including business, law enforcement, and military applications. Such applications demand efficient, user-friendly email systems that minimize errors and minimize the time required to communicate via email.

Email systems often include communications software running on a client computer having Internet access. Exemplary client-side communications software applications include Microsoft_{®} Outlook or Outlook Express and Netscape_{®} Messenger. Alternatively, a server maintains email software that is accessed remotely by clients with Internet access via a browser. The server-side email software maintains individual accounts for various clients and controls messaging for each account. The clients employ a website interface to access their email accounts. Exemplary websites that include such email systems include www.hotmail.com and www.mail.com.

Conventionally, when a user wishes to send an email message to a recipient, the user locates the email address of the recipient, enters the email address in the email software, types the email message, includes any attachments, and then sends the message to the recipient. This process of obtaining the recipient's email address and then entering the email address is often inefficient, time consuming, and error-prone, particularly when several emails must be sent to various recipients.

To overcome these inefficiencies, electronic address books and related databases were developed to store email addresses and related information. A user may select the email address of an intended recipient from the address book or database. A time-consuming, error-prone perusal or search of the address book is often required to select the addresses for the intended recipients. Consequently, name and email address spelling errors often occur when the user sends emails to recipients with unfamiliar names or email addresses.

Some email software applications employ and auto-entry method wherein email addresses are automatically entered into an email address field when the user begins typing the names of the recipients in the email address field. Unfortunately, with this method, recipients with similar names are often erroneously selected as recipients. This is particularly true for large corporate email communications applications where companies with multiple workers having similar names are common. Consequently, this auto-entry address-selection method is often undesirably error-prone. Furthermore, a user may not remember the name(s) of the intended recipient(s). Consequently, the user may need to perform a time-consuming perusal of an email address book to find the appropriate email addresses.

Address books may be stored on the client computer or a server. When the address book is stored on a server, the client must often download the address book before preparing emails offline, i.e., when not connected to the Internet. Downloading an address book is often undesirably time-consuming. Furthermore, email address books are often not user-configurable. This reduces the ability of a user to streamline email address selection to meet the needs of the user.

Conventional email software and related communications applications lack an efficient mechanism for organizing emails according to the frequency or recency of use so that a user may quickly select email addresses from a list of the most frequently or recently used email addresses.

Hence, a need exists in the art for an efficient and user-friendly email communications system and accompanying method for facilitating rapid email address selection with minimal errors. There exists a further need for an accompanying efficient system for facilitating email address selection that is user-configurable and does not require downloading of an address book when the user is working offline.

### SUMMARY OF THE INVENTION

The need in the art is addressed by the system for facilitating email communications of the present invention. In the illustrative embodiment, the inventive system adapted for use with the Internet and web-based communications systems. The inventive system includes a first mechanism for monitoring when emails are sent and/or how often the emails are sent to different email addresses and providing a signal in response thereto. A second mechanism selectively displays a list of most recently used email addresses and/or most frequently used email addresses based on the signal and in response to user input.

In a specific embodiment, the first mechanism includes email address usage-tracking software that communicates with email communications software. Email address sorting software interfaces with the email address usage-tracking software. The email address sorting software employs a data structure that contains priorities associated with a predetermined number of email addresses. Methods for assigning priorities to the email addresses and the size of the data structure are user-configurable via a user-interface to the email address sorting software. The data structure is implemented as an email address book or other type of data structure, such as a software queue. The email address sorting software sorts email addresses in the data structure according to priority values assigned to each email. The priority values are based on user-input to the email address sorter and based on the signal. The second mechanism further includes an additional mechanism for displaying a sorted drop-down list or menu of email addresses selected from the data structure and sorted according to the priority values.

In a more specific embodiment, the data structure is implemented as a priority queue. The email address sorting software includes functionality that selectively increments a priority value assigned to a given email address when an email is sent to the given email address. The email address sorting software includes additional functionality that selectively deletes email address priority values from the priority queue to limit the size of the data structure to a predetermined maximum size.

The novel design of the present invention is facilitated by the second mechanism, which provides a user-configurable sorted list of convenient email addresses. Generally, these convenient email addresses are the most recently and/or the most frequently used email addresses. Consequently, a user may efficiently select email addresses from a user-friendly list that facilitates rapid email address selection with minimal errors.

### BRIEF DESCRIPTION OF THE DRAWINGS

FIG. 1 is a block diagram of key functional modules of a system for facilitating email communications of the present invention.

FIG. 2 is a flow diagram of a method employed by the system of FIG. 1 and implemented in software via the various modules of FIG. 1.

FIG. 3 is a flow diagram of software that may be employed to facilitate implementation of the system of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

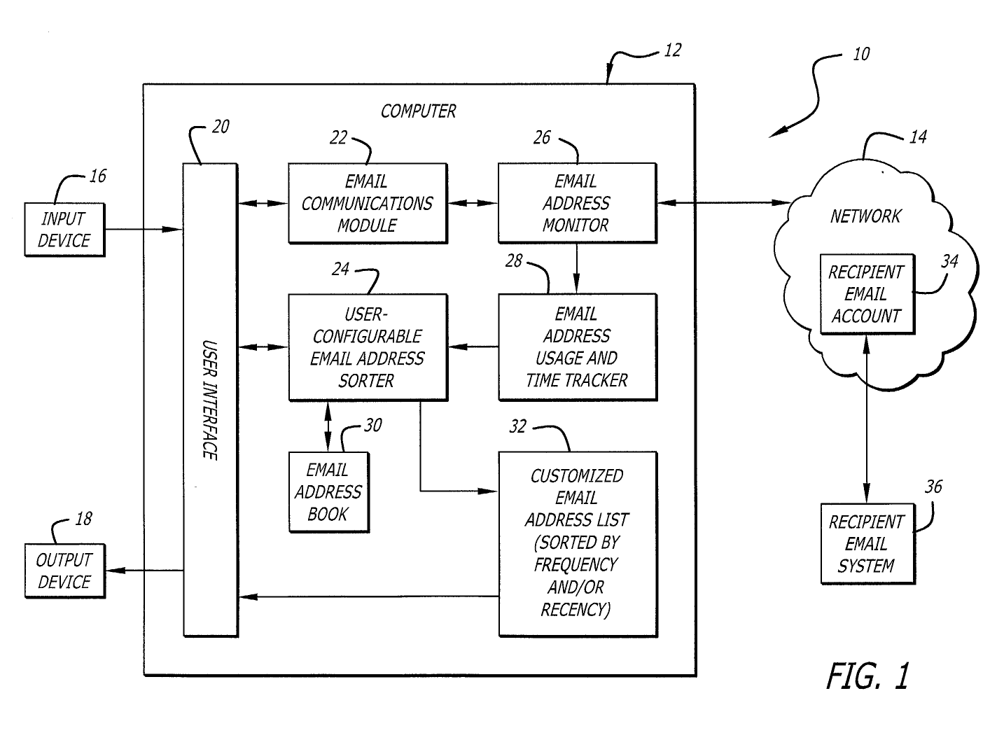

FIG. 1 is a block diagram of key functional modules of a system 10 for facilitating email communications of the present invention. For clarity, various well-known components, such as computer operating systems, power supplies, and so on, have been omitted from FIG. 1. However, those skilled in the art with access to the present teachings will know which components to implement and how to implement them to meet the needs of a given application.

The system 10 includes a computer 12 that is connected to a network 14, such as the Internet, and is connected to a user-input device 16, such as a keyboard or mouse, and to a user-output device 18, such as a computer monitor. The computer 12 runs various software modules including a user interface 20, an email communications module 22, a user-configurable email address sorter 24, an email address monitor 26, an email address usage and time tracker 28, an email address book 30, and a customized email address list display module 32.

The user interface 20 interfaces the email communications module 22, the user-configurable email address sorter 24, and the email address list 32 with the user via the user-input device 16 and the user-output device 18. The email communications module 22 communicates with an exemplary recipient email account 34 on the network 14. The recipient email account 34 is accessible to a recipient via a recipient email system 36, which may be constructed similarly to the system 10. The communications of the communications module 22 are monitored via the email address monitor 26. The email address monitor 26 communicates with the email address usage and time tracker 28, which forwards information to the user-configurable email address sorter 24. The user-configurable email address sorter 24 communicates with the email address book 30 and receives user-input via the user interface 20. The interface 20 may be implemented as a conventional Graphical User Interface (GUI) that is displayed via the output device 18. Output from the user-configurable email address sorter 24 is provided to the customized email address list 32, which is selectively displayed to the user via the user interface 20 in response to predetermined user-input.

For the purposes of the present invention, an email is any message sent electronically to an entity associated with an electronic address. Hence, email includes point-to-point communications such as telegraphs and facsimiles. Consequently, an email address may refer to a fax number or other number or address designation indicating the destination of the electronic message. Email also includes electronic messages sent via computer-based message systems, wherein a received electronic text file can be edited, replied to, excerpted, or pasted into another electronic document that can be used or manipulated by a work processor, desktop publisher, or other computer program. Such computer-based message systems are often called store-and-forward or mailbox systems. These systems are often employed to broadcast messages to multiple recipients, read and discard messages, file and retrieve messages, or forward messages to other users. Computer-based email messaging may occur on a single computer, between computers connected to a network, or across gateways linking different computer networks, such as through the Internet. While the system 10 of FIG. 1 is discussed in terms of a computer-based email application, one skilled in the art may apply the teachings of the present invention to general point-to-point electronic communications systems.

In operation, a user sends emails to recipients, such as the recipient 36, by activating the email communications module 22 via the user-input device 16 and the user interface 20. The mail communications module 22 may be implemented as a standard communications software package, such as Microsoft® Outlook or Netscape® Messenger. Conventionally, to send an email to a recipient 36, a user enters a destination email address associated with the recipient email account 34 into the email communication module 22; then types the desired email message; and then sends the message.

The email addresses system 10 may track sent emails and determine which email addresses are used most frequently and which were used most recently. The most frequently used email addresses and/or the most recently used email addresses are then displayed via the customized email address list 32 via a drop-down list or menu item implemented via the user interface and displayed via the output device 18. A user may quickly select email addresses from the sorted list 32, which reduces the tedious and error-prone practice of manually entering destination email addresses or selecting them from entries in a conventional electronic address book.

As the user sends email to recipients on the network 14, the email address monitor 26 monitors email communications between the network 14 and the email communications module 22. When an email is sent, or when several emails are sent in parallel, the email address monitor 26 activates the email address usage and time tracker 28. In the present specific embodiment, the email address usage and time tracker 28 notes when the email is sent and tracks how often the email is sent during a predetermined time interval. This time interval may vary according to the number of emails sent and the frequency at which the emails are being sent as discussed more fully below. For example, if the user rarely sends emails, this time interval will be longer than if the user frequently sends emails. The email address monitor 26 may also monitor received emails and their associated addresses in addition to or instead of sent email addresses so that a list of email addresses corresponding to the most frequently received emails may be displayed to facilitate user-selection of email addresses.

In the present specific embodiment, the email address usage and time tracker 28 associates each email address with a time value corresponding to the last time the email address was used and/or a frequency value indicative of how often the email address is used. The time value and the frequency value may be combined into one value as discussed more fully below.

In the present specific embodiment, the user-configurable email address sorter 24 files the sent email addresses and their corresponding time and frequency values in the email address book 30, which may alternatively be implemented as a software data structure, such as a queue, as discussed more fully below. The user-configurable email address sorter 24 then selectively sorts email addresses in the address book based on the time and/or frequency values and user-input to generate the customized email address list 32. The customized email address list 32 may be a subset of the email addresses contained in the email address book 30, without departing from the scope of the present invention.

The user-configurable email address sorter 24 provides user-configurable options to the user via the user interface 20. In the present embodiment, these options include options for selecting the length of the customized email address list 32, whether the email address list 32 should be sorted by recency and/or frequency, whether the customized email address list 32 should be displayed as a drop-down list or menu, and whether received email addresses in addition to or instead of sent email addresses should be included in the list 32.

If the user configures the user-configurable email address sorter 24 to display email addresses according to recency, then the customized email address list 32 will list email addresses in order of decreasing recency. In this case, more recently employed email addresses are higher in the list, and less frequently used emails are lower in the list. Similarly, if the user configures the user-configurable email address sorter 24 to display email addresses according to frequency, the list 32 lists email addresses sorted according to frequency of use. Similarly, if the user selects the option to display a list of received (as opposed to sent) email addresses according to frequency, the customized email address list 32 will include received email addresses listed according to the frequency at which emails are received from the associated email addresses. If the user selects the option to display a combination of both received email addresses and sent email addresses, then the list 32 will include both sent and received email addresses sorted by recency or frequency as established by the user-input to the user-configurable email address sorter 24.

The address book 30 may be implemented as a database, such as an Oracle database. Alternatively, the address book 30 may be implemented via one or more programming language data structures, such as such as a queue, a stack, a heap, and so on, without departing from the scope of the present invention.

By displaying most recently used or most frequently used email addresses in a convenient drop-down list or menu and allowing user selection of one or more email addresses from the list, the system 10 reduces the possibility of sending emails to incorrect email addresses. Furthermore, the system 10 reduces the need to repetitively look up unfamiliar email addresses. For example, after an email is sent to an unfamiliar email address, the email address will appear in the customized email address list 32. This reduces misspellings of unfamiliar names and associated email addresses and generally increases the user-friendliness of the email communications system 10.

Furthermore, in environments wherein a separate email address book is not located on the computer 12, and the email address book 30 is implemented as a data structure, such as a priority queue, the system 10 may obviate the need for the user to download the separate email address book when working offline. This is because the email addresses in the data structure 30 may suffice as the address book.

In an illustrative embodiment, the user-configurable email address sorter 24 may be configured to select any user-chosen subset of the email address book 30 for inclusion in the customized email address list 32. For example, a user may wish to include particularly problematic or error-prone email addresses in the customized email address list 32 instead of or in addition to most recently used and/or frequently used email addresses. Exact details of the user-configurable email address sorter 24 are application-specific and may be determined by one skilled in the art with access to the present teachings to meet the needs of a given application.

One skilled in the art with access to the present teachings may readily implement the various software modules 20-32 via a programming language, such as C++, without undue experimentation. In addition, one skilled in the art will appreciate that the system 10 may be adapted to work with email addresses sent individually, email addresses sent in parallel, and groups of email addresses. For example, the customized email address list 32 may include email address groups, listed by group name, with each group name associated with several email addresses. When a user selects a group from the customized email address list 32, all email addresses in the group are included in a broadcast email. Each time the group is used, as monitored by the email address monitor 26, the priority of the group is adjusted via the email address usage and time tracker 28 and the user-configurable email address sorter 24. The group is then sorted in the customized email address list 32 according to the priority value assigned to the group via the user-configurable email address sorter 24.

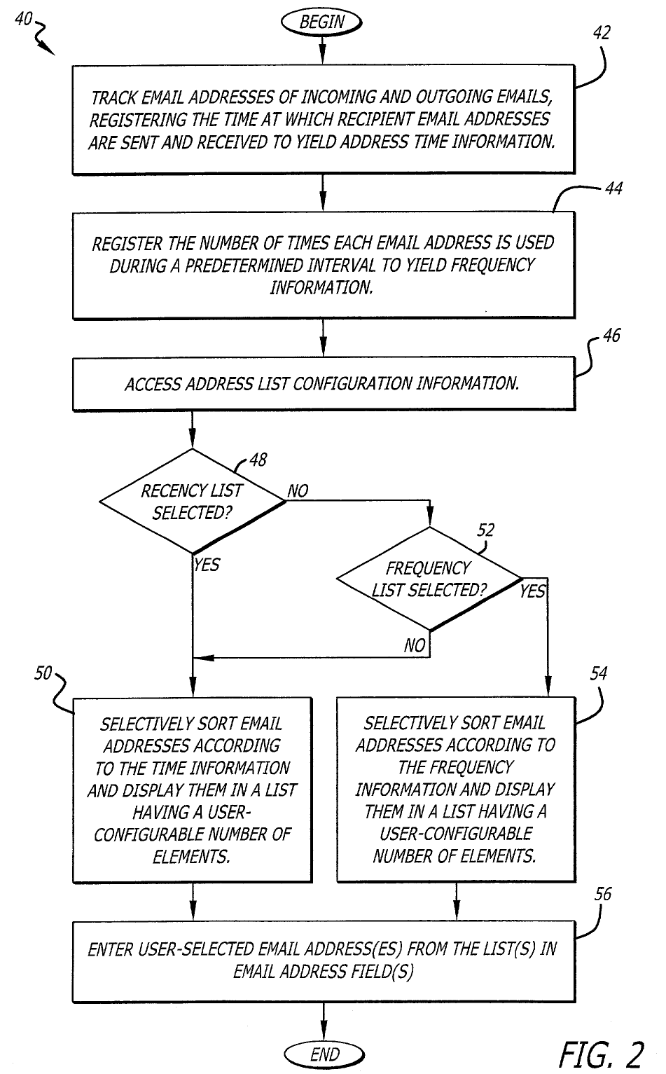

FIG. 2 is a flow diagram of a method 40 employed by the system 10 of FIG. 1 and implemented in software via the various modules 20-32 of FIG. 1. The method 40 includes an initial time-tracking step 42 wherein the email addresses of incoming and outgoing emails are tracked. The time at which the email addresses are employed is saved. This time information may be used to determine how recently email addresses have been employed.

Subsequently, control is passed to a frequency-tracking step 44, where the number of times the email addresses are used in a predetermined interval is saved as frequency information. The time information and frequency information may be employed to compute how recently or frequently, respectively, a given email address has been used. The time information and the frequency information may be combined into a single priority value (priority count) as discussed more fully below. Subsequently, control is passed to a list-configuring step 46.

In the list-configuring step 46, address list configuration information is accessed to retrieve any user-configurable sorting parameters that were set by the user. For example, the configuration parameters include parameters specifying if the user has chosen to construct a list based on most recently used email addresses and/or most frequently used email addresses. The length of the list is specified in a separate parameter. The user may set these parameters via the user-input device 16, the user interface 20, and the user-configurable email address sorter 24 of FIG. 1. Alternatively, these parameters may be assigned default parameters, which are predetermined based on the needs of the application.

Subsequently, control is passed to a recency-checking step 48, wherein the user-specified configuration parameters are checked to determine if the user has chosen to sort the email address list (see 32 of FIG. 1) according to how recently each email address has been used. If the user has chosen to sort the email addresses based on when the email addresses were used, then control is passed to a recency-sorting step 50.

In the recency-sorting step 50, email addresses are sorted into a list based on when they were employed. The most recently used email addresses are at the top of the list, while less recently used email addresses are positioned lower in the list. The length of the list is user-configurable and is obtained in the list-configuring step 46.

If the user has not chosen to sort email addresses based on recency as determined in the recency-checking step 48, then control is passed from the recency-checking step 48 to a frequency-checking step 52. In the frequency-checking step 52, software (see 24 of FIG. 1) determines, by referencing the user-configuration parameters, if the user has chosen to sort the email address list according to the frequency at which the constituent email addresses are used. If the parameter indicating that the list of email addresses should be sorted by frequency is set, then control is passed to a frequency-sorting step 54.

In the frequency-sorting step 54, the list of email addresses is sorted in order of decreasing frequency of use. Consequently, more frequently used email addresses are higher in the list than less frequently used email addresses. The list is displayed in a drop-down menu or other type of list or menu that may be selectively activated via user input, such as via the clicking of a mouse on a software button.

After completion of the recency-sorting step 50 or the frequency-sorting step 54, a convenient list of email addresses, are available and selectable by the user. In an alternative embodiment, both a recency-based email address list and a frequency-based email address list are made available to the user in response to corresponding user-input to the user-configurable email address sorter 24 of FIG. 1.

After completion of the recency-sorting step 50 or the frequency-sorting step 54, control is passed to an address-selection step 56, where the user selects one or more addresses from the sorted list(s). The selected email address(es) is then automatically entered into an address field of the email communication module (see 22 of FIG. 1) in preparation for sending an email to the recipient(s) associated with the selected email address(es), and the method 40 is complete.

Alternatively, control may be passed back to the email-tracking step 42 from the address-selection step 56. The method 40 then completes when the user closes or deactivates the email address monitoring software 26 of FIG. 1 or exits the email communications module 22.

Those skilled in the art will appreciate that the order of the steps 48 and 52 may be switched without departing from the scope of the present invention. Furthermore, the decisions of steps 48 and 52 may be replaced with different types of decisions without departing from the scope of the present invention. Furthermore, additional decision steps may be employed. Any additional or different types of decisions employed in a similar method may be application-specific and may depend on which parameters of the sorted address list are configurable by the user via the user-configurable email address sorter 24 of FIG. 1.

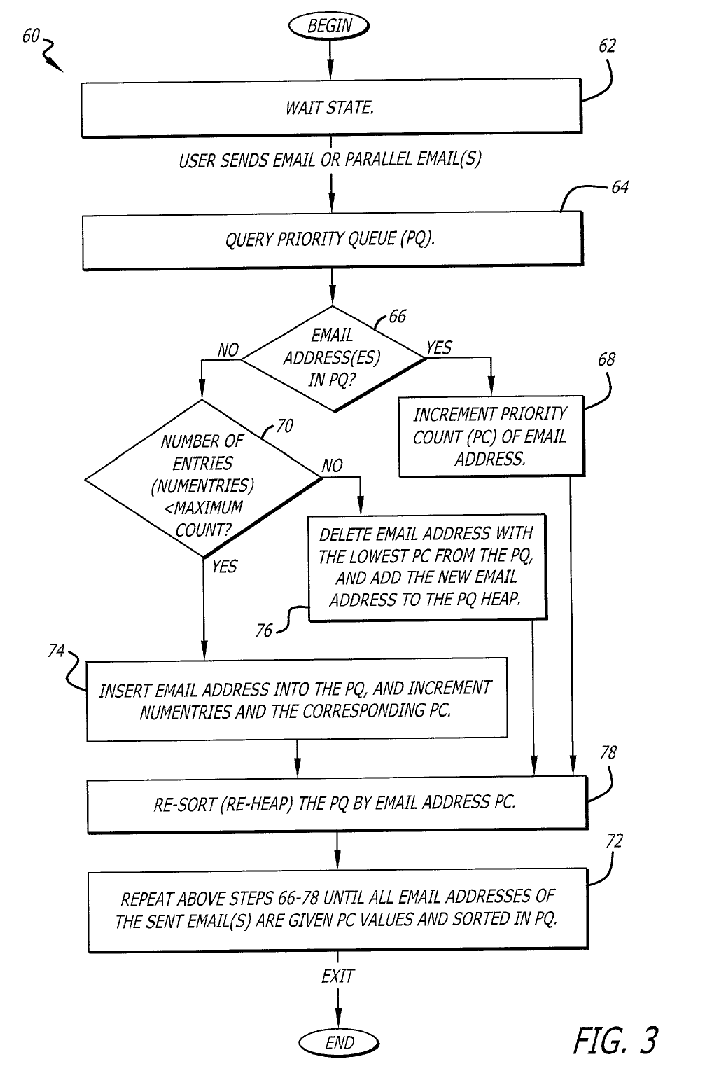

FIG. 3 is a flow diagram of software 60 that may be employed to facilitate implementation of the system 10 of FIG. 1. With reference to FIGS. 1 and 3, the software 60 implements the email address monitor 26, the email address usage and time tracker 28, and the user-configurable email address sorter 24 of FIG. 1.

The software 60 enters a wait state 62 as it monitors the output of the email communications module 22. When the user sends an email or several emails in parallel via the email communications module 22, the software queries a priority queue in a queue-querying step 64 to determine if a first email address of the sent email addresses is in the priority queue in a first decision step 66. If the first email address is in the priority queue, then control is passed to an initial incrementing step 68, wherein the priority count of the first email address is incremented by a predetermined amount before the priority queue is re-sorted in a queue-sorting step 78. If the first email address is not in the priority queue, then the software 60 checks if the number of entries in the priority queue are less than a predetermined user-configurable maximum count in a queue-size checking step 70.

If the number of entries in the priority queue is less than the maximum count, then the email address is inserted into the priority queue. Then the corresponding priority count is set to a predetermined initial value, such as zero, and is then incremented by a predetermined amount, such as by 1, in an address-insertion step 74. The amount by which the priority count is incremented or reduced is application-specific as discussed more fully below.

If the number of entries in the priority queue is equal to the maximum count, then one or more email addresses are deleted from the priority queue before the same number of email addresses are added to the queue in an address-deletion step 76. In the present specific embodiment, the address-deletion step 76 and the address-insertion step 74 handle one email address at a time. Consequently, the number of entries in the priority queue will never be larger than the maximum count.

In the address-deletion step 76, the email address with the lowest priority count or value is deleted from the priority queue before the new address and corresponding priority count are included in the queue. The priority count assigned to the newly inserted email address is assigned a predetermined initial value, which is incremented by a predetermined amount, such as by one, before control is passed to a queue sorting step 78.

After the new email address is inserted in the priority queue along with a priority count, control is passed to the queue-sorting step 78, where the priority queue is re-sorted according to the priority counts of constituent email addresses. Subsequently, in a repeating step 72, the steps 66-78 are repeated as necessary until all email addresses included in the sent email are inserted into the priority queue and given priority count values. For example, if several emails are sent in parallel, the steps 66-78 repeat until the software 60 assigns each email address a priority count if it does not already have one and inserts each email address in the priority queue if it is not already inserted. For email addresses pre-existing in the priority queue, the corresponding priority counts are incremented when emails are sent to those email addresses.

In the present specific embodiment, the software 60 sorts email addresses in the user-selectable address list to be displayed to the user in order of frequency of use. By incrementing the priority count for each email address as it is used and re-sorting the email address based on the corresponding priority count, more frequently used emails are placed higher in the list than less frequently used emails, since more frequently used emails will have larger priority counts.

The software 60 may also be employed to sort email addresses in the customized email address list 32 of FIG. 1 based on both how recently and how frequently the email addresses are used. For example, a user may specify, via one or more configuration parameters, that each time a new email address is added to the priority queue that the priority count values associated with the other email addresses already in the priority queue are reduced by a predetermined amount. Consequently, as time passes, the priority counts of email addresses that have not been recently used decrease accordingly. As a specific example, each time an email addresses is used, the corresponding priority count is incremented by three, while the other priority counts in the priority queue are reduced by one. The increment amounts and decrement amounts may be user-configurable.

The priority counts for email addresses are preferably less than a predetermined maximum value. This maximum value is application-specific and may be readily determined by one skilled in the art to meet the needs of a given application. When a priority count reaches its maximum value, the incrementing operations in steps 74 and 76 are bypassed.

A minimum value for the maximum number of entries in the customized email address list 32 of FIG. 1 may also be user-configurable. The minimum value for the maximum number of entries in the list 32 affects the behavior of the software 60. For example, if the maximum number of entries is small, the software 60 may often delete email addresses from the priority queue having higher priority values than the initial priority value of the email address set to replace the deleted email address. This issue becomes less problematic as the value for the maximum number of entries in the priority queue increases.

To address this issue when the maximum size of (i.e., the number of entries in) the priority queue is small, the software 60 may be adjusted so that new email addresses are inserted into the list 32 only when the lowest priority count in the list 32 is less than the initial priority count to be assigned to the newly inserted email address. In this embodiment, the priority counts associated with the email addresses in the priority queue are set to decay over time so that a priority value of an email address in the priority queue will eventually be smaller than the initial value chosen for newly used email addresses. The priority counts may be set to decay over time by decrementing the priority counts in the priority queue each time the priority queue is analyzed by the software 60 in response to the sending of an email by the user. The rate of the decay may be adjusted by selectively configuring the amount by which each priority count is reduced each time the priority queue is accessed or analyzed.

The predetermined values assigned to the priority counts, the maximum number of entries allowed in the priority list, the minimum number of the maximum number of entries, and the increment and decrement amounts for the priority counts are user-configurable parameters, which are configurable via the user-configurable email address sorter 24 and user interface 20 of FIG. 1.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

What is claimed is:

1. A system for facilitating email communications comprising:
first means for monitoring when emails are sent and/or how often the emails are sent to different email addresses and providing a signal in response thereto and
second means for selectively displaying a list of most recently used email addresses and/or most frequently used email addresses based on said signal in response to user input.

2. The system of claim 1 wherein said first means includes email address usage-tracking software in communication with email communications software.

3. The system of claim 2 wherein said second means includes email address sorting software in communication with said email address usage-tracking software, said email address sorting software employing a data structure containing priorities associated with a predetermined number of email addresses.

4. The system of claim 3 wherein said predetermined number of email addresses and methods for assigning priorities to said email addresses are user-configurable via a user-interface to said email address sorting software.

5. The system of claim 4 wherein said data structure is implemented as an email address book designed to allow said email address sorting software to sort email addresses in said address book according to priority values assigned to each email based on user-input to said email address sorter and based on said signal.

6. The system of claim 5 wherein said second means includes means for displaying a sorted drop-down list or menu of email addresses selected from said email address book and sorted according to said priority values.

7. The system of claim 4 wherein said data structure is implemented as a priority queue.

8. The system of claim 7 wherein said email address sorting software includes means for selectively incrementing a priority value assigned to a given email address when an email is sent to said given email address, and includes means for selectively deleting email address priority values from said priority queue to limit the size of said data structure to a predetermined maximum size.

9. A system for facilitating email communications comprising:
first means for sending an email and providing a signal in response thereto when said email is sent to a recipient associated with a predetermined email address;
second means for assigning a priority to said email address based on said signal and predetermined configuration information;
third means for sorting said email address in a list of email addresses according to said priority; and
fourth means for displaying said list of email addresses.

10. The system of claim 9 wherein said first means includes an email software application running on a computer.

11. The system of claim 10 wherein said second means includes a user interface in communication with a user-input device and said email software package for providing user-configurable options for specifying said configuration information to determine said priority based on said signal.

12. The system of claim 11 wherein said user-configurable options include frequency and recency options, which when selected, assign higher priorities to more frequently used email addresses or more recently used addresses, respectively.

13. The system of claim 11 wherein said configurable options include a list size option, a maximum value of said priority, and/or an amount by which to increment or decrement said priority of each email address in said list via said second means in response to said signal.

14. The system of claim 13 wherein said third means includes means for sorting said list in order of decreasing priority as indicated by said priority value.

15. The system of claim 14 wherein said third means includes a user-configurable email address sorter.

16. The system of claim 14 wherein said fourth means includes a drop-down list or a menu in communication with said third means.

17. A method for facilitating email communications by selectively providing a list of most recently used email addresses and/or most frequently used email addresses comprising the steps of:
tracking incoming and outgoing emails and registering the time at which recipient email addresses are sent and received to yield address time information;
registering the number of times each email address is used during a predetermined interval to yield frequency information;
accessing user-configuration information associated with said list;
determining if a recency-based list, a frequency-based, or a combination thereof is selected by said user based on said configuration information and providing a signal in response thereto;
sorting said list of email addresses in order of recency and/or frequency and providing a sorted list in response thereto; and
selectively displaying said sorted list in response to user input.

18. A software package for facilitating email communications from a device having an email communications package comprising:
first means for monitoring email communications to determine when an email is sent to a recipient email address and providing a first signal in response thereto;
second means for querying a data structure containing email addresses sorted according to predetermined priority values in response to said first signal and providing a second signal in response thereto;
third means for determining a total number of entries in said data structure and whether said recipient email address is in said data structure based on said second signal and providing a third signal in response thereto;
fourth means for removing a low-priority email address from said data structure; inserting said recipient email address in said data structure; and assigning said email address an initial priority value when said number of entries in said data structure are equal to a maximum size as indicated by said third signal;
fifth means for inserting said email address into said data structure and assigning said recipient email address said initial priority value when said recipient email address is not in said data structure as indicated by said third signal;
sixth means for incrementing said priority value of said recipient email address by a predetermined increment value when said recipient email address is already in said data structure as indicated by said third signal;
seventh means for sorting said data structure according to priority values associated with each email address in said data structure after said priority of said email address is altered by said fourth, fifth, or sixth means; and
eighth means for selectively displaying contents of said data structure to a user in response to predetermined user input.

19. The software package of claim 18 wherein said software package further includes means for selectively invoking said second through eighth means when emails are sent in parallel to plural email addresses until all of said plural email addresses are assigned priority values and either placed in said data structure or removed from said data structure.

20. The software package of claim 18 further including means for altering said increment value in response to user-input.

21. The software package of claim 20 further including means for establishing said maximum size of said data structure based on user-input.

22. A method for facilitating email communications comprising the steps of:
monitoring when emails are sent and/or how often the emails are sent to different email addresses and providing a signal in response thereto and selectively displaying a list of most recently used email addresses and/or most frequently used email addresses based on said signal in response to user input.
